(19) United States
(12) Patent Application Publication
(10) Pub. No.: US 2017/0058856 A1
(43) Pub. Date: Mar. 2, 2017

(54) HIGH FREQUENCY GENERATING DEVICE AND HIGH FREQUENCY GENERATING METHOD USED IN PLASMA IGNITION APPARATUS

(71) Applicant: FUJITSU TEN LIMITED, Kobe-shi (JP)

(72) Inventors: Yusuke MASUDA, Kobe-shi (JP); Masashi SHIBAYAMA, Kobe-shi (JP)

(73) Assignee: FUJITSU TEN LIMITED, Kobe-shi (JP)

(21) Appl. No.: 15/203,974

(22) Filed: Jul. 7, 2016

(30) Foreign Application Priority Data
Aug. 27, 2015 (JP) 2015-167903

(51) Int. Cl. F02P 11/06; F02P 9/00; H05H 1/46; F02P 23/04

(52) U.S. Cl. CPC F02P 11/06; F02P 23/04; F02P 9/002; H05H 1/46; H05H 2001/463

(57) ABSTRACT

A high frequency generating device used in a plasma ignition apparatus according to embodiments includes an output unit and a control unit. The output unit outputs a high frequency to an antenna that irradiates the high frequency into a combustion chamber of an internal-combustion engine. The control unit instructs the output unit to output the high frequency on the basis of an ignition signal that controls a spark discharge by an ignition plug and a control signal that controls output of the high frequency. Moreover, the control unit determines, when one of the ignition signal and the control signal is input, whether or not the other signal is input within a predetermined detection period, and detects abnormality in an input path of the ignition signal or in an input path of the control signal when the other signal is not input within the predetermined detection period.

### CROSS-REFERENCE TO RELATED APPLICATION

This application is based upon and claims the benefit of priority of the prior Japanese Patent Application No. 2015-167903, filed on Aug. 27, 2015, the entire contents of which are incorporated herein by reference.

### FIELD

The embodiment discussed herein is directed to a high frequency generating device and a high frequency generating method used in a plasma ignition apparatus.

### BACKGROUND

Conventionally, in an internal-combustion engine such as an automobile engine, a plasma ignition apparatus is proposed that supplies, for the expansion of a plasma region, a high frequency to a spark discharge as a core of the plasma to ignite an air-fuel mixture. Herein, the spark discharge is generated in a combustion chamber by using an ignition plug. This kind of plasma ignition apparatus includes a high frequency generating device that generates the high frequency.

There is known a high frequency generating device, for example, that generates the high frequencies in both states, measures reflected waves in both the states, and compares intensities of the measured reflected waves to detect abnormality of the high frequency generating device, in which both the states include a state in which the air-fuel mixture is not supplied into the combustion chamber and a state in which the air-fuel mixture is supplied and burned by a spark discharge (for example, Japanese Laid-open Patent Publication No. 2014-185544).

However, the aforementioned conventional technology has room for improvement in easily specifying occurrence points of the abnormality.

### SUMMARY

A high frequency generating device used in a plasma ignition apparatus according to embodiments includes an output unit and a control unit. The output unit outputs a high frequency to an antenna that irradiates the high frequency into a combustion chamber of an internal-combustion engine. The control unit instructs the output unit to output the high frequency on the basis of an ignition signal that controls a spark discharge by an ignition plug and a control signal that controls output of the high frequency. Moreover, the control unit determines, when one of the ignition signal and the control signal is input, whether or not the other signal is input within a predetermined detection period, and detects abnormality in an input path of the ignition signal or in an input path of the control signal when the other signal is not input within the predetermined detection period.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view illustrating a high frequency generating method used in a plasma ignition apparatus according to embodiments;

FIG. 2 is a block diagram illustrating a configuration of a high frequency generating device according to a first embodiment;

FIG. 3 is a diagram illustrating a determination process by a determination unit;

FIG. 4 is a diagram illustrating an example of abnormality information;

FIG. 5 is a flow chart illustrating a procedure for an abnormality detection process that is executed by the high frequency generating device according to the first embodiment;

FIG. 6 is a flow chart illustrating a procedure for an abnormality detection process that is executed by a high frequency generating device according to a second embodiment;

FIG. 7 is a diagram illustrating a determination process according to a third embodiment;

FIG. 8 is a diagram illustrating an example of abnormality information according to the third embodiment; and

FIG. 9 is a diagram illustrating a determination process according to a forth embodiment.

### DESCRIPTION OF EMBODIMENTS

Hereinafter, embodiments of a high frequency generating device and a high frequency generating method used in a plasma ignition apparatus disclosed in the present application will be described in detail with reference to the accompanying drawings. In the present embodiments, explanation is performed in an example that the plasma ignition apparatus is used in an automobile engine. However, the plasma ignition apparatus may be used in an internal-combustion engine other than the automobile engine. Moreover, the present invention is not limited to embodiments described below.

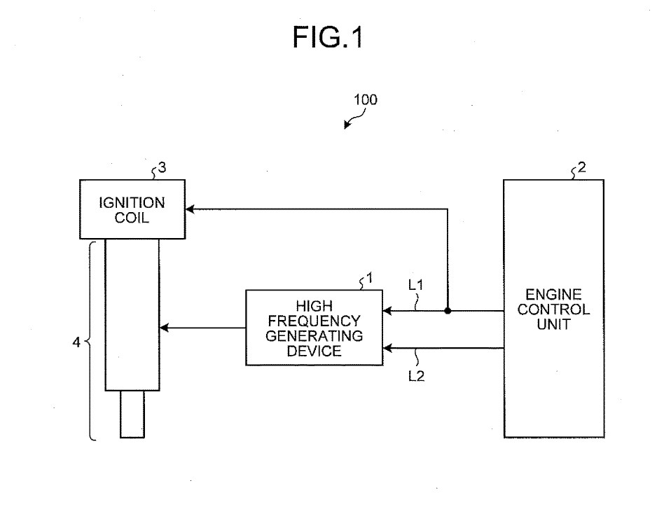

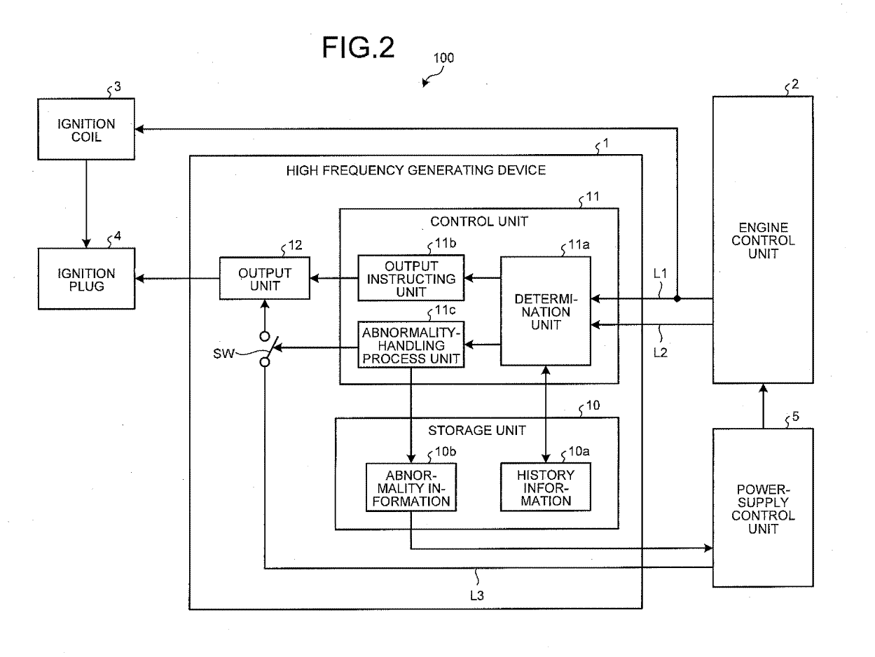

Hereinafter, summaries of a high frequency generating method used in a plasma ignition apparatus according to the present embodiments will be explained with reference to FIG. 1, and subsequently, a high frequency generating device that employs the high frequency generating method will be explained with reference to FIGS. 2 to 9.

First, the summaries of the high frequency generating method will be explained with reference to FIG. 1. FIG. 1 is a schematic view illustrating the high frequency generating method used in a plasma ignition apparatus 100 according to embodiments.

As illustrated in FIG. 1, the plasma ignition apparatus 100 includes a high frequency generating device 1, an engine control unit 2, an ignition coil 3, and an ignition plug 4.

The engine control unit 2 outputs an ignition signal to the ignition coil 3 at timing corresponding to a driving situation of the vehicle or the like. The ignition signal is a signal for controlling a time at which a spark discharge is generated by the ignition plug 4. The ignition signal is also input to the high frequency generating device 1.

The engine control unit 2 outputs to the high frequency generating device 1 a setting signal (corresponding to one example of ‘control signal’) including setting parameters such as output level and irradiation start timing of the high frequency.

The ignition and setting signals are output in pairs. In other words, the ignition and setting signals are input in pairs into the high frequency generating device 1, in principle. The ignition signal is input into the high frequency generating device 1 through a first input path L1, and the setting signal is input into the high frequency generating device 1 through a second input path L2.

The high frequency generating device 1 generates the high frequency on the basis of the ignition and setting signals that are input from the engine control unit 2.

Specifically, a state of the high frequency generating device 1 shifts from a non-output state to a output ready state of the high frequency when the ignition signal is input to the high frequency generating device 1. The high frequency generating device 1 stores a plurality of irradiation conditions each of which includes output level, irradiation start timing, or the like of the high frequency, and loads an irradiation condition that corresponds to the setting signal from the irradiation conditions. When the irradiation start timing determined by the irradiation condition arrives at the high frequency generating device 1, the high frequency generating device 1 generates the high frequency and outputs it to the ignition plug 4.

The ignition coil 3 receives the ignition signal from the engine control unit 2 and generates a high voltage. Specifically, the ignition coil 3 includes a primary coil and a secondary coil (not illustrated), cuts off a current that flows through the primary coil, and thus generates the high voltage in the secondary coil by an induction phenomenon. The high voltage having generated in the ignition coil 3 is supplied to the ignition plug 4.

The ignition plug 4 includes a center electrode and a ground electrode that is arranged so as to have a narrow gap from the center electrode, and the high voltage from the ignition coil 3 is imposed on the center electrode to generate a spark discharge in a space of the narrow gap.

When a high frequency (microwave) is supplied from the high frequency generating device 1, the ignition plug 4 also functions as an antenna that irradiates the high frequency into the combustion chamber. When the high frequency is irradiated into the combustion chamber from the ignition plug 4, a plasma region is enlarged by supplying the high frequency to a spark discharge as a core of the plasma, and an air-fuel mixture in the combustion chamber is ignited. Thus, for example, when driving the engine with an air-fuel mixture that is leaner than the theoretical air-fuel ratio, the air-fuel mixture can be combusted stably. A dedicated antenna for irradiating the high frequency into the combustion chamber may be provided separately from the ignition plug 4. In this case, the high frequency generating device 1 supplies the high frequency to the dedicated antenna.

When some abnormality occurs in a high frequency generating device to lead to malfunction in output of a high frequency in a conventional technology, it is not easy to specify a point at which the abnormality occurs because there are various conceivable abnormality points such as abnormality in the device itself that includes abnormality in an output unit that outputs the high frequency, leakage of an output high frequency or abnormality in an input path of a signal that is input into the high frequency generating device.

The high frequency generating device 1 according to the present embodiments determines, when one of the ignition and setting signals is input, whether or not the other signal is input within a predetermined detection period. The high frequency generating device 1 detects, when the other signal is not input within the detection period, abnormality in the first input path L1 that is an input path of the ignition signal or abnormality in the second input path L2 that is an input path of the setting signal.

Thus, the high frequency generating device 1 according to the present embodiments can easily specify that the abnormality occurrence point is in the first input path L1 or the second input path L2.

The high frequency generating device 1 according to the present embodiments performs a predetermined abnormality handling process when the abnormality is detected, and thus it becomes possible that malfunction such as, for example, a misfire by outputting the high frequency at unintended timing or leakage of the high frequency from the combustion chamber is prevented from occurring. As the abnormality handling process, the high frequency generating device 1, for example, inhibits output of the high frequency, or cuts off the power-supply path to the output unit that performs oscillation and amplification of the high frequency. These points will be mentioned later.

### First Embodiment

1. Configuration of High Frequency Generating Device

Hereinafter, the first embodiment of the high frequency generating device 1 that employs the aforementioned high frequency generating method will be explained with reference to FIGS. 2 to 5. FIG. 2 is a block diagram illustrating a configuration of the high frequency generating device 1.

As illustrated in FIG. 2, the high frequency generating device 1 includes a storage unit 10, a control unit 11, and an output unit 12. The high frequency generating device 1 further includes a power-supply path L3 and a switch SW.

1-1. Power-Supply Path and Switch

The power-supply path L3 is a path for supplying a voltage from a power-supply control unit 5 to the output unit 12. The switch SW is provided on the power-supply path L3, and switches between a supply state and a supply cut-off state of the voltage to the output unit 12.

Now, the power-supply control unit 5 will be explained. The power-supply control unit 5 is connected to a not illustrated on-vehicle battery, and boosts a supply voltage (for example, 12 V) from the on-vehicle battery up to a predetermined voltage (for example, 32 V) and supplies the boosted voltage to the output unit 12.

The power-supply control unit 5 performs a process or the like in which the power-supply control unit 5 acquires abnormality information 10b having stored in the storage unit 10 of the high frequency generating device 1 and sends it to the engine control unit 2.

1.2 Output Unit

The output unit 12 generates the high frequency in accordance with an instruction from an output instructing unit 11b to be mentioned later, and outputs it to the ignition plug 4 that doubles as an antenna. The output unit 12 operates by a supply voltage from the power-supply control unit 5 supplied through the power-supply path L3.

1.3 Storage Unit

The storage unit 10 is constituted by a storage device such as, for example, a semiconductor memory device such as a Random Access Memory (RAM) and a flash memory, a hard disk, and an optical disk. The storage unit 10 stores history information 10a and the abnormality information 10b.

The history information 10a is information that indicates input history of the ignition and setting signals to the high frequency generating device 1, and is stored by the storage unit 10. The history information 10a is information that includes a type (ignition signal or setting signal) of signals that are input to a determination unit 11a, input time of the signal, or the like.

The abnormality information 10b is information that is output from an abnormality-handling process unit 11c when the abnormality is detected by the determination unit 11a to be mentioned later. The abnormality information 10b is information that includes combination of presence or absence of input to the determination unit 11a of the ignition and setting signals. Contents of the abnormality information 10b will be explained later with reference to FIG. 4.

1.4 Control Unit

The control unit 11 includes the determination unit 11a, the output instructing unit 11b, and the abnormality-handling process unit 11c. The control unit 11 is, for example, a microcomputer that includes a Central Processing Unit (CPU), a Random Access Memory (RAM), and a Read Only Memory (ROM). The CPU functions as the determination unit 11a, the output instructing unit 11b, and the abnormality-handling process unit 11c by, for example, performing an operation process in accordance with a program previously stored in the ROM.

1-4-1. Determination Unit

The determination unit 11a is connected to the first and second input paths L1 and L2, and receives the input of the ignition and setting signals.

The determination unit 11a determines the presence or absence of input of the ignition and setting signals, and outputs the input ignition and setting signals to the output instructing unit 11b when both the ignition and setting signals are input within a predetermined period. On the contrary, the determination unit 11a detects abnormality in the first input path L1 or the second input path L2 when only one of the signals is input within a predetermined period, and outputs a detection result to the abnormality-handling process unit 11c.

When the ignition signal or the setting signal is input, the determination unit 11a also performs a process which stores input history of the input signal in the storage unit 10 as the history information 10a that includes, for example, time of turning ON and time of turning OFF of the ignition signal or the setting signal.

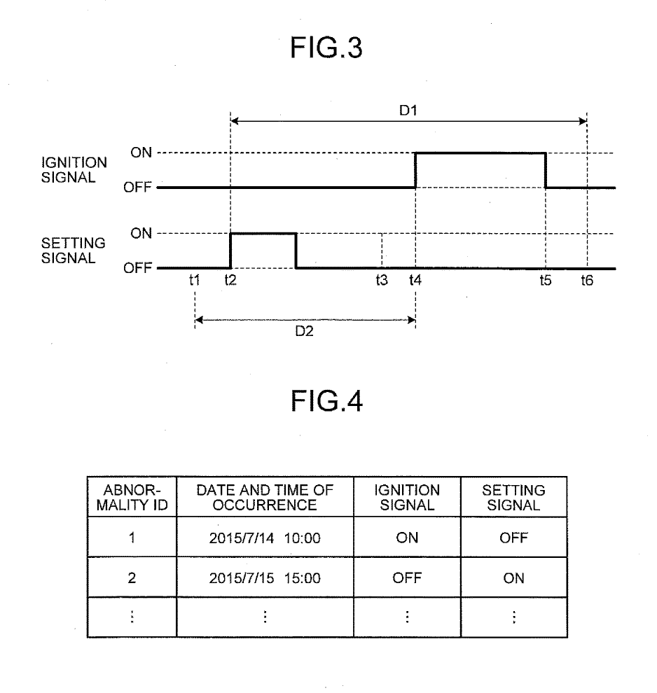

Now, details of a determination process by the determination unit 11a will be explained with reference to FIG. 3. FIG. 3 is a diagram illustrating the determination process by the determination unit 11a. In FIG. 3, input timing of each of the signals when the ignition and setting signals are input normally is illustrated.

As illustrated in FIG. 3, the setting signal is input to the determination unit 11a prior to the ignition signal. This is because, for example, times required for setting output level, irradiation start timing, or the like are considered. For example, as illustrated in FIG. 3, when it is assumed that the ignition signal has input at a time t4, the setting signal is input within a predetermined period (for example, within period from time t2 to time t3) that is prior to the time t4.

The setting signal includes a plurality of input patterns whose input timings or input times within the period from the time t2 to the time t3 are different from each other, and it is recognized by the input patterns that which of the setting conditions of a signal corresponds to the input setting information.

When the setting signal is input, the determination unit 11a determines the presence or absence of input of the ignition signal within the first detection period D1 that is a period after input of the setting signal (first determination process). The first detection period D1 is a period in which, for example, the time t2 is a start point when the setting signal is turned ON, and a time t6 is an end point posterior to an OFF time t5 of the ignition signal when assuming that the ignition signal is input normally.

In the first determination process, when the ignition signal is input within the first detection period D1, in other words, when the ignition signal is input by the time t6, the determination unit 11a determines normal input of the signal, and outputs the input ignition signal and setting signal to the output instructing unit 11b. On the other hand, when the ignition signal is not input within the first detection period D1, because there is a possibility that abnormality occurs in the first input path L1 or the second input path L2, concretely, a sky fault occurs suddenly in an input line of the setting signal, the setting signal is generated by a noise, or disconnection or a ground fault occurs in an input line of the ignition signal, the determination unit 11a detects the abnormality of the first input path L1 or the second input path L2, and outputs a detection result to the abnormality-handling process unit 11c.

The determination unit 11a refers to the history information 10a stored in the storage unit 10 when it is not in the first determination process, in other words, the ignition signal is input during other than the first detection period D1, and determines whether or not the setting signal has input within the second detection period D2 that is a period prior to input of the ignition signal (second determination process). The second detection period D2 is a period in which, for example, the ON time t4 of the ignition signal is an end point, and the time t1 is a start point that is prior to a period (from time t2 to time t3) in which the setting signal is to be input.

In the second determination process, the determination unit 11a determines normal input of the signal when the setting signal is input within the second detection period D2, and outputs the input ignition signal and setting signal to the output instructing unit 11b. On the other hand, when the setting signal is not input within the second detection period D2, the determination unit 11a detects the abnormality in the first input path L1 or the second input path L2, and outputs a detection result to the abnormality-handling process unit 11c.

In the second determination process, when the setting signal is input within the second detection period D2, the setting signal is also detected in the first determination process, and then the ignition signal is detected within the first detection period D1. In other words, when the ignition signal is input during other than the first determination process, namely during other than the first detection period D1, it follows that the setting signal is not input, the abnormality in the first input path L1 or the second input path L2 can be detected without determining whether or not the setting signal is input within the second detection period D2 in the second determination process. Therefore the process can be simplified.

The aforementioned start points and end points of the first detection period D1 and the second detection period D2 are only one example. For example, it may be possible that the first detection period D1 corresponds to a period from the time t4 to the time t5 and the second detection period D2 corresponds to a period from the time t2 to the time t3.

In this way, because the determination unit 11a can restrict the detection period by performing the first determination process and the second determination process on the assumption that the ignition signal is input after the setting signal is input, processing load of the determination can be reduced.

In the example of the case of FIG. 3, the setting signal and the ignition signal are input in this order. However, order of input of them is not limited to the aforementioned example and, for example, the ignition signal and the setting signal may be input in this order or input at substantially the same time.

When the setting signal and the ignition signal are input at substantially the same time, the first detection period D1 for determination of the ignition signal and the second detection period D2 for determination of the setting signal may be the same period.

1-4-2. Output Instructing Unit

Return to explanation of FIG. 2, the output instructing unit 11b will be explained. When the ignition and setting signals are input from the determination unit 11a, the output instructing unit 11b instructs the output unit 12 to output the high frequency on the basis of the signals.

Specifically, when the ignition signal is input, the output instructing unit 11b shifts a state of the output unit 12 from the non-output state to the output ready state of the high frequency. Also, when the setting signal is input, the output instructing unit 11b loads the irradiation condition that corresponds to the setting signal, and instructs the output unit 12 to output the high frequency when the irradiation start timing arrives that is determined by the irradiation condition.

1-4-3. Abnormality-Handling Process Unit

When the abnormality is detected by the determination unit 11a, the abnormality-handling process unit 11c performs a predetermined abnormality handling process.

For example, the abnormality-handling process unit 11c inhibits output of the high frequency by the output unit 12. The abnormality-handling process unit 11c inhibits, for example, the determination unit 11a from outputting the ignition and setting signals to the output instructing unit 11b. In other words, even if the ignition and setting signals are input to the determination unit 11a, the determination unit 11a is to prevent the input ignition signal and setting signal from being output to the output instructing unit 11b. Therefore, because the output instructing unit 11b does not instruct the output unit 12 to output the high frequency, the output of the high frequency by the output unit 12 is substantially inhibited. As a result, it is possible to prevent erroneous output of the high frequency from the high frequency generating device 1 which has detected the abnormality. Moreover, the abnormality-handling process unit 11c may instruct the determination unit 11a not to perform the determination process even if the ignition and setting signals are input.

The abnormality-handling process unit 11c may control the switch SW that is provided on the power-supply path L3 to cut off power supply to the output unit 12. Therefore, even if the output instructing unit 11b instructs the output unit 12 to output the high frequency in response to a signal from the determination unit 11a, the output unit 12 cannot generate the high frequency, and thus erroneous output of the high frequency from the high frequency generating device 1 in which the abnormality is detected is prevented.

As the abnormality handling process, the abnormality-handling process unit 11c stores in the storage unit 10a determination result by the determination unit 11a as the abnormality information 10b. Specifically, the abnormality-handling process unit 11c stores the abnormality information 10b in the storage unit 10 that includes combination of the presence or absence of the ignition signal and the presence or absence of the setting signal.

Now, contents of the abnormality information 10b will be explained with reference to FIG. 4. FIG. 4 is a diagram illustrating an example of the abnormality information 10b. The abnormality information 10b illustrated in FIG. 4 is only one example, and not limited to this, for example, a diagnostic code that presents an abnormality state of a vehicle may be used.

As illustrated in FIG. 4, the abnormality information 10b includes items such as ‘abnormality ID’, ‘date and time of occurrence’, ignition signal', and ‘setting signal’.

The ‘abnormality ID’ is identification number of the detected abnormality, and the ‘date and time of occurrence’ is date and time when the abnormality is detected by the determination unit 11a.

The ‘ignition signal’ and the ‘setting signal’ are ON/OFF information of the ignition and setting signals in such a case that abnormality is detected by the determination unit 11a. For example, in an example illustrated in FIG. 4, the abnormality ID ‘1’ presents that abnormality occurs at ‘10:00 A.M. on Jul. 14, 2015’, and about signals when the abnormality is detected, the ignition signal is ‘ON’, in other words, the ignition signal is input, and the setting signal is ‘OFF’, in other words, the setting signal is not input.

The abnormality information 10b stored in the storage unit 10 is output by the power-supply control unit 5. The power-supply control unit 5 outputs the acquired abnormality information 10b to the engine control unit 2. The engine control unit 2 can perform control such as stopping output of the setting signal on the basis of the abnormality information 10b.

The abnormality-handling process unit 11c may directly output the abnormality information 10b to an external device (for example, power-supply control unit 5) of the high frequency generating device 1 without through the storage unit 10.

In this way, because the abnormality information 10b is stored and the repairer carries out the repair on the basis of the abnormality information 10b, when the repair of the high frequency generating device 1 that has detected the abnormality is carried out, for example, occurrence points of the abnormality can be specified easily, and thus a repair time can be shortened.

For example, in a situation in which the abnormality ID illustrated in FIG. 4 is ‘1’, in other words, the ignition signal is ‘ON’ and the setting signal is ‘OFF’, two abnormality patterns (first and second abnormality patterns) are supposed. The first abnormality pattern is a situation in which the setting signal is normal but the ignition signal continues to be input. The second abnormality pattern is a situation in which the ignition signal is normal, but input of the setting signal is lost. Therefore, the abnormality-handling process unit 11c or the repairer can specify contents of the abnormality when the abnormality ID is ‘1’ as a sky fault (first abnormality pattern) in the first input path L1, or disconnection or a ground fault (second abnormality pattern) in the second input path L2.

In a situation in which the abnormality ID is ‘2’, in other words, the ignition signal is ‘OFF’ and the setting signal is ‘ON’, two abnormality patterns (third and fourth abnormality patterns) are also supposed. The third abnormality pattern is a situation in which the setting signal is normal, but input of the ignition signal is lost. The fourth abnormality pattern is a situation in which the ignition signal is normal, but the setting signal continues to be input. Therefore, the abnormality-handling process unit 11c or the repairer can specify contents of the abnormality when the abnormality ID is ‘2’ as disconnection or a ground fault (third abnormality pattern) in the first input path L1, or a sky fault (fourth abnormality pattern) in the second input path L2.

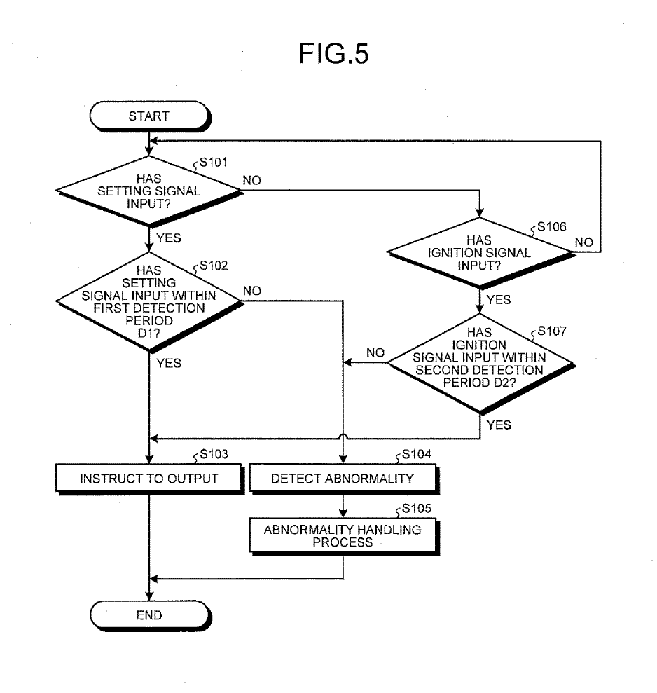

Next, a sequence for an abnormality detection process executed by the high frequency generating device 1 according to the first embodiment will now be described with reference to FIG. 5. FIG. 5 is a flow chart illustrating the procedure for the abnormality detection process that is executed by the high frequency generating device 1 according to the first embodiment.

As illustrated in FIG. 5, the determination unit 11a determines whether or not the setting signal is input from the engine control unit 2 (Step S101). In the determination process, when the setting signal is input (Step S101: Yes), the determination unit 11a determines whether or not the ignition signal is input from the engine control unit 2 within the first detection period D1 (Step S102).

When the ignition signal is input within the first detection period D1 (Step S102: Yes), the output instructing unit 11b instructs the output unit 12 to output the high frequency (Step S103). Otherwise, when the ignition signal is not input within the first detection period D1 (Step S102: No), the determination unit 11a detects the abnormality in the first input path L1 or the second input path L2 (Step S104), and the abnormality-handling process unit 11c performs the abnormality handling process (Step S105).

Otherwise, when the setting signal is not input (Step S101: No), the determination unit 11a determines whether or not the ignition signal is input (Step S106). In this determination process, when the ignition signal is input (Step S106: Yes), the determination unit 11a determines whether or not the setting signal is input from the engine control unit 2 within the second detection period D2 referring to the history information 10a (Step S107).

In Step S107, when the setting signal is input within the second detection period D2 (Step S107: Yes), the output instructing unit 11b instructs the output unit 12 to output the high frequency (Step S103). Otherwise, when the setting signal is not input within the second detection period D2 (Step S107: No), the determination unit 11a detects the abnormality in the first input path L1 or the second input path L2 (Step S104), and the abnormality-handling process unit 11c performs the abnormality handling process (Step S105).

In Step S106, when the ignition signal is not input (Step S106: No), the determination unit 11a shifts a process to Step S101.

As described above, the high frequency generating device 1 according to the first embodiment includes the output unit 12 and the control unit 11. The output unit 12 outputs the high frequency to the ignition plug 4 as an antenna which irradiates the high frequency into the combustion chamber of an engine. The control unit 11 instructs the output unit 12 to output the high frequency on the basis of the ignition signal that controls the spark discharge and the setting signal (corresponding to one example of control signal) that controls output of the high frequency. When one of the ignition signal and the control signal is input, the control unit 11 determines whether or not the other signal is input within a predetermined detection period, and when the other signal is not input within the detection period, the control unit 11 detects the abnormality in the first input path L1 or the second input path L2.

Therefore, by employing the high frequency generating device 1 according to the first embodiment, the abnormality occurrence points are easily specified.

### Second Embodiment

Next, the high frequency generating device 1 according to the second embodiment will be explained. For example, there may be a situation in which a noise such as a reverse current from the ignition coil 3 is mixed in the first input path L1 and the noise is erroneously input to the determination unit 11a as the ignition signal. In this case, the setting signal is not input, and thus the determination unit 11a detects the abnormality.

Therefore, the high frequency generating device 1 according to the second embodiment detects the abnormality when, for example, the ignition signal is input and a situation in which the setting signal is not input continuously occurs more than predetermined number of times. As a result, it is possible not to detect a temporal abnormality by a noise as the abnormality.

Specifically, it is supposed that, for example, the ignition signal is input and the setting signal is not input. In the case, the determination unit 11a checks presence or absence of input of the ignition and setting signals that have determined at the time of previous determination of the latest determination.

Now, in a case where the ignition signal is input and the setting signal is not input in a detection result of the time of the previous determination, it results in that the same situation continues with respect to the two successive determinations. In the case, the determination unit 11a detects abnormality.

As a result, the high frequency generating device 1 according to the second embodiment can exclude a case in which the abnormality may be detected only once by a noise such as a reverse current from the ignition coil 3. In other words, it is possible to exclude an erroneous determination of the determination unit 11a by a noise. In the aforementioned example, the predetermined number of times is set to be twice, but is not limited thereto.

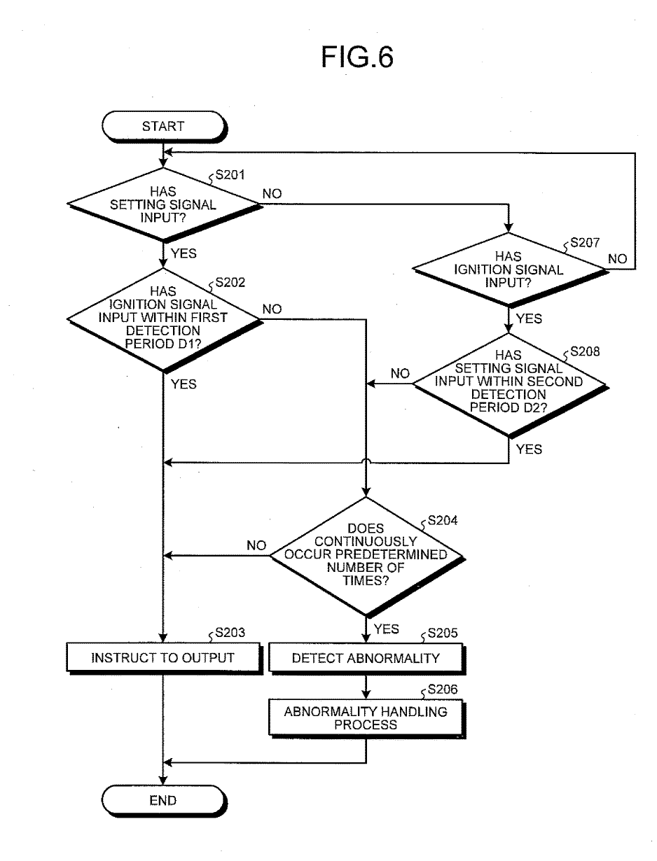

Next, a sequence for an abnormality detection process executed by the high frequency generating device 1 according to the second embodiment will be explained with reference to FIG. 6. FIG. 6 is a flow chart illustrating the procedure for the abnormality detection process that is executed by the high frequency generating device 1 according to the second embodiment.

As illustrated in FIG. 6, the determination unit 11a determines whether or not the setting signal is input from the engine control unit 2 (Step S201). In the determination process, when the setting signal is input (Step S201: Yes), the determination unit 11a determines whether or not the ignition signal is input from the engine control unit 2 within the first detection period D1 (Step S202).

When the ignition signal is input within the first detection period D1 (Step S202: Yes), the output instructing unit 11b instructs the output unit 12 to output the high frequency (Step S203). Otherwise, when the ignition signal is not input within the first detection period D1 (Step S202: No), the determination unit 11a determines whether or not a situation in which the setting signal is input and the ignition signal is not input continuously occurs predetermined number of times (Step S204).

In Step S204, when the situation in which the setting signal is input and the ignition signal is not input continuously occurs the predetermined number of times (Step S204: Yes), the determination unit 11a detects abnormality in the first input path L1 or the second input path L2 (Step S205), and the abnormality-handling process unit 11c performs the abnormality handling process (Step S206).

Otherwise, when the situation in which the setting signal is input and the ignition signal is not input does not continuously occur the predetermined number of times (Step S204: No), for example, when the situation has occurred only once, the output instructing unit 11b instructs the output unit 12 to output the high frequency (Step S203).

When the setting signal is not input (Step S201: No), the determination unit 11a determines whether or not the ignition signal is input (Step S207). In the determination process, when the ignition signal is input (Step S207: Yes), the determination unit 11a determines whether or not the setting signal is input from the engine control unit 2 within the second detection period D2 referring to the history information 10a (Step S208).

In Step S208, when the setting signal is input within the second detection period D2 (Step S208; Yes), the output instructing unit 11b instructs the output unit 12 to output the high frequency (Step S203). Otherwise, when the setting signal is not input within the second detection period D2 (Step S208: No), the determination unit 11a shifts the process to Step S204. In the case of Step S204, it is determined whether or not a situation in which the setting signal is not input continuously occurs a predetermined number of times. In Step S207, when the ignition signal is not input (Step S207: No), the determination unit 11a shifts the process to Step S201.

As described above, in the second embodiment, the determination unit 11a detects the abnormality in the first input path L1 or the second input path L2 when the same situation in which one of the ignition and setting signals is not input within a predetermined detection period continuously occurs predetermined number of times.

Therefore, by employing the high frequency generating device 1 according to the second embodiment, it is possible not to erroneously detect a temporal abnormality by a noise as the abnormality.

### Third Embodiment

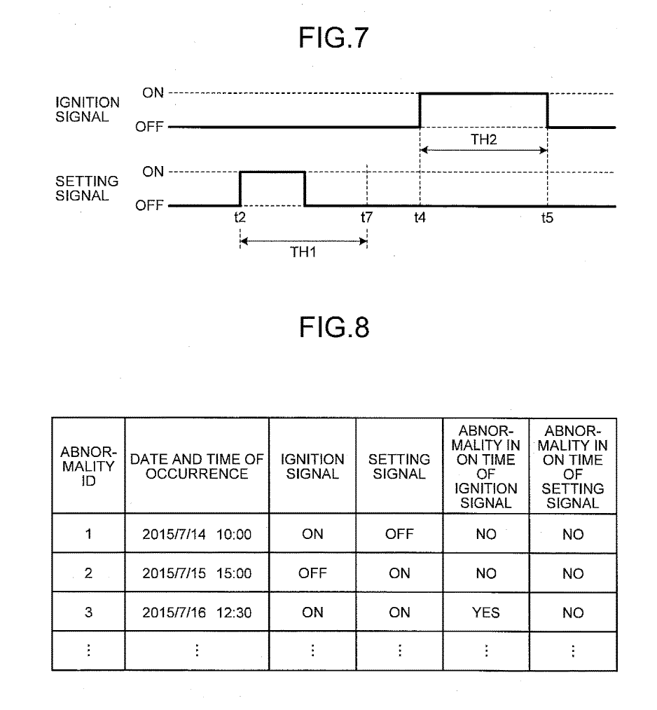

Next, the high frequency generating device 1 according to the third embodiment will be explained with reference to FIGS. 7 to 9. The high frequency generating device 1 according to the third embodiment performs a determination process on the basis of an ON time of the input signal.

Specifically, the determination unit 11a detects the abnormality in an input path of the setting signal when an input time of the setting signal exceeds a predetermined threshold (first threshold). The determination unit 11a detects the abnormality in an input path of the ignition signal when an input time of the ignition signal exceeds a predetermined threshold (second threshold).

In other words, the determinations are performed by input ‘time point’ in the first and second embodiments, whereas performed by an input ‘time period’ in the third embodiment. When an input time period of one of the ignition and setting signals exceeds the threshold, it is possible to specify that the abnormality occurs in an input path of the signal.

Now, details of a determination process by the determination unit 11a according to the third embodiment will be explained with reference to FIG. 7. FIG. 7 is a timing chart illustrating the determination process according to the third embodiment.

As illustrated in FIG. 7, the determination unit 11a determines that the setting signal is input when the setting signal turns ‘ON’ at, for example, the time point t2 in addition to the cases of the first and second embodiments. Moreover, the determination unit 11a detects the abnormality in the second input path L2 that is an input path of the setting signal when an ‘ON’ state of the setting signal exceeds a preset first threshold TH1 (time point t7).

The determination unit 11a determines that the ignition signal is input when the ignition signal turns ‘ON’ at the time point t4. Moreover, the determination unit 11a detects the abnormality in the first input path L1 that is an input path of the ignition signal when an ‘ON’ state of the ignition signal exceeds a preset second threshold TH2 (time point t5).

Next, contents of the abnormality information 10b according to the third embodiment will be explained with reference to FIG. 8. FIG. 8 is a diagram illustrating an example of abnormality information 10b according to the third embodiment. Items of ‘abnormality ID’, ‘date and time of occurrence’, ‘ignition signal’, and ‘the setting signal’ illustrated in FIG. 8 overlap with those illustrated in FIG. 4, and thus explanation about them will be omitted.

As illustrated in FIG. 8, the abnormality information 10b according to the third embodiment includes items such as the ‘abnormality ID’, the ‘date and time of occurrence’, the ‘ignition signal’, the ‘setting signal’, ‘abnormality in ON time of ignition signal’, and ‘abnormality in ON time of setting signal’.

The ‘abnormality in ON time of ignition signal’ is information that presents whether or not an ON time period of the ignition signal exceeds the second threshold TH2, and the ‘abnormality in ON time of setting signal’ is information that presents whether or not an ON time period of the setting signal exceeds the first threshold TH1.

The abnormality-handling process unit 11c stores the abnormality information 10b that presents ‘YES’ when an ON time period of each of the signals exceeds the corresponding threshold, and presents ‘NO’ when an ON time period of each of the signals is less or equal to the corresponding threshold.

For example, in FIG. 8, the abnormality ID ‘3’ presents abnormality in which both the ignition and setting signals are input within the detection period, but the ignition signal exceeds the second threshold TH2. In the case, it is presented that the ignition signal continues to be input, and thus, for example, occurrence of a sky fault in the first input path L1 that is an input path of the ignition signal can be specified.

As described above, in the third embodiment, the determination unit 11a detects the abnormality in the second input path L2 when the input time period of the setting signal exceeds the first threshold TH1, and detects the abnormality in the first input path L1 when the input time period of the ignition signal exceeds the second threshold TH2.

As a result, the high frequency generating device 1 according to the third embodiment can specify which of the first and second input paths L1 and L2 has the abnormality.

### Fourth Embodiment

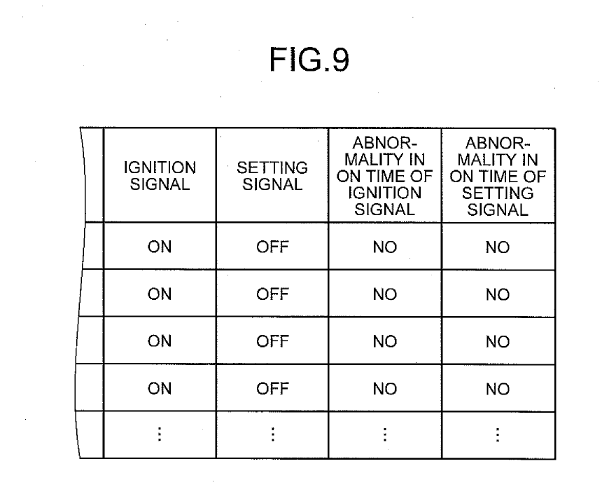

Next, the high frequency generating device 1 according to the fourth embodiment will be explained with reference to FIG. 9. FIG. 9 is a diagram illustrating the determination process according to the forth embodiment.

In FIG. 9, the abnormality information 10b is illustrated in such a case that a situation continuously occurs a plurality of times in which the ignition signal is ‘ON’, the setting signal is ‘OFF’, the abnormality in ON time of the ignition signal is ‘NO’, and the abnormality in ON time of the setting signal is ‘NO’.

Such a situation presents that the setting signal input from the second input path L2 is lost. Thus, in this case, the high frequency generating device 1 can specify that the present abnormality is disconnection in the second input path L2.

As described above, in the fourth embodiment, the determination unit 11a detects the abnormality by combining a determination of the input time periods of the ignition and setting signals and a determination of whether or not the same situation continuously occurs a plurality of times in which one of the ignition and setting signals is not input.

Therefore, the high frequency generating device 1 according to the fourth embodiment can specify which of the first and second input paths L1 and L2 has the abnormality.

In the aforementioned embodiments, the setting signal including setting parameters such as output level of the high frequency and the irradiation start timing is explained to be one example of the control signal. However, not limited thereto, it is sufficient that the control signal controls output of the high frequency of the high frequency generating device 1.

Also, not limited to only one control signal, the control signal may include a plurality of control signals. For example, signals of the output level of the high frequency and the irradiation start timing may be respectively input to the high frequency generating device 1 through different input paths. In the case, when it is determined that all of the ignition signal and the plurality of control signals are input, the determination unit 11a outputs them to the output instructing unit 11b. Therefore, the output instructing unit 11b instructs the output unit 12 to output the high frequency at the output level and at the irradiation start timing corresponding to the plurality of control signals.

As a result, the output level of the high frequency and the irradiation start timing can be set respectively by different control signals, and thus the number of combination of the output level and the irradiation start timing of the high frequency increases, the irradiation condition can be set more precisely.

On the contrary, when at least one signal of the ignition signal and the plurality of the control signals is not input, the determination unit 11a detects abnormality in input paths of the ignition signal and the plurality of the control signals. As a result, the high frequency generating device 1 can easily specify abnormality occurrence points.

For example, when the ignition signal and the control signal that controls the output level of the high frequency are input, and the control signal that controls the irradiation start timing is not input, it is supposed that possibility of disconnection in the input path of the control signal that controls the irradiation start timing is larger than possibility of a sky fault in the input path of the control signal that controls the ignition signal and the output level.

In other words, because possibility in which the abnormality occurs at only one point is larger than possibility in which the abnormality occurs at two points simultaneously, for example, when the repair is carried out, possibility in which the repairer early discovers the abnormality is large. In this way, possibility in which the abnormality is discovered early in a case where the number of the control signals is plural is larger than in a case where the number of the control signal is one, and thus it is possible to specify the abnormality occurrence points easier.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A high frequency generating device used in a plasma ignition apparatus, the high frequency generating device comprising:
an output unit that outputs a high frequency to an antenna that irradiates the high frequency into a combustion chamber of an internal-combustion engine; and
a control unit that instructs the output unit to output the high frequency on a basis of an ignition signal that controls a spark discharge by an ignition plug and a control signal that controls output of the high frequency, wherein
the control unit determines, when one of the ignition signal and the control signal is input, whether or not another signal is input within a predetermined detection period, and detects abnormality in an input path of the ignition signal or in an input path of the control signal when the other signal is not input within the predetermined detection period.

2. The high frequency generating device used in the plasma ignition apparatus according to claim 1, wherein the control unit detects the abnormality in the input path of the ignition signal or in the input path of the control signal when a situation in which the other signal is not input within the detection period continuously occurs a predetermined number of times.

3. The high frequency generating device used in the plasma ignition apparatus according to claim 1, wherein the control unit determines presence or absence of input of the ignition signal within a first detection period after the control signal is input, and determines presence or absence of input of the control signal within a second detection period before the ignition signal is input.

4. The high frequency generating device used in the plasma ignition apparatus according to claim 2, wherein the control unit determines presence or absence of input of the ignition signal within a first detection period after the control signal is input, and determines presence or absence of input of the control signal within a second detection period before the ignition signal is input.

5. The high frequency generating device used in the plasma ignition apparatus according to any one of claims 1, wherein the control unit detects the abnormality in the input path of the control signal when an input time of the control signal exceeds a first threshold, and detects the abnormality in the input path of the ignition signal when an input time of the ignition signal exceeds a second threshold.

6. The high frequency generating device used in the plasma ignition apparatus according to any one of claims 2, wherein the control unit detects the abnormality in the input path of the control signal when an input time of the control signal exceeds a first threshold, and detects the abnormality in the input path of the ignition signal when an input time of the ignition signal exceeds a second threshold.

7. The high frequency generating device used in the plasma ignition apparatus according to any one of claims 4, wherein the control unit detects the abnormality in the input path of the control signal when an input time of the control signal exceeds a first threshold, and detects the abnormality in the input path of the ignition signal when an input time of the ignition signal exceeds a second threshold.

8. The high frequency generating device used in the plasma ignition apparatus according to any one of claims 1, the high frequency generating device further comprising a storage unit that stores information, wherein
the control unit stores in the storage unit abnormality information that includes a combination of presence or absence of input of the ignition signal and presence or absence of input of the control signal when detecting the abnormality.

9. The high frequency generating device used in the plasma ignition apparatus according to any one of claims 2, the high frequency generating device further comprising a storage unit that stores information, wherein
the control unit stores in the storage unit abnormality information that includes a combination of presence or absence of input of the ignition signal and presence or absence of input of the control signal when detecting the abnormality.

10. The high frequency generating device used in the plasma ignition apparatus according to any one of claims 7, the high frequency generating device further comprising a storage unit that stores information, wherein
the control unit stores in the storage unit abnormality information that includes a combination of presence or absence of input of the ignition signal and presence or absence of input of the control signal when detecting the abnormality.

11. The high frequency generating device used in the plasma ignition apparatus according to any one of claims 1, wherein the control unit outputs to an external device abnormality information that includes a combination of presence or absence of input of the ignition signal and presence or absence of input of the control signal when detecting the abnormality.

12. The high frequency generating device used in the plasma ignition apparatus according to any one of claims 2, wherein the control unit outputs to an external device abnormality information that includes a combination of presence or absence of input of the ignition signal and presence or absence of input of the control signal when detecting the abnormality.

13. The high frequency generating device used in the plasma ignition apparatus according to any one of claims 7, wherein the control unit outputs to an external device abnormality information that includes a combination of presence or absence of input of the ignition signal and presence or absence of input of the control signal when detecting the abnormality.

14. The high frequency generating device used in the plasma ignition apparatus according to any one of claims 1, wherein the control unit inhibits the output unit from outputting the high frequency when detecting the abnormality.

15. The high frequency generating device used in the plasma ignition apparatus according to any one of claims 2, wherein the control unit inhibits the output unit from outputting the high frequency when detecting the abnormality.

16. The high frequency generating device used in the plasma ignition apparatus according to any one of claims 10, wherein the control unit inhibits the output unit from outputting the high frequency when detecting the abnormality.

17. The high frequency generating device used in the plasma ignition apparatus according to any one of claims 13, wherein the control unit inhibits the output unit from outputting the high frequency when detecting the abnormality.

18. The high frequency generating device used in the plasma ignition apparatus according to claim 14, the high frequency generating device further comprising:
a power-supply path to the output unit; and
a switch provided on the power-supply path, wherein
the control unit controls the switch to cut off power supply to the output unit when detecting the abnormality.

19. The high frequency generating device used in the plasma ignition apparatus according to claim 15, the high frequency generating device further comprising:
a power-supply path to the output unit; and
a switch provided on the power-supply path, wherein
the control unit controls the switch to out off power supply to the output unit when detecting the abnormality.

20. A high frequency generating method used in a plasma ignition apparatus, the high frequency generating method comprising:
outputting a high frequency to an antenna by using an output unit that outputs the high frequency to the antenna, the antenna irradiating the high frequency into a combustion chamber of an internal-combustion engine;
instructing the output unit to output the high frequency on a basis of an ignition signal that controls a spark discharge by an ignition plug and a control signal that controls output of the high frequency;
determining, when one of the ignition signal and the control signal is input, whether or not another signal is input within a predetermined detection period; and
detecting abnormality in an input path of the ignition signal or in an input path of the control signal when the other signal is not input within the predetermined detection period.
